(19) United States
(12) Patent Application Publication
(10) Pub. No.: US 2019/0347776 A1
(43) Pub. Date: Nov. 14, 2019

(54) IMAGE PROCESSING METHOD AND IMAGE PROCESSING DEVICE

(71) Applicant: ALTEK CORPORATION, Hsinchu City (TW)

(72) Inventors: Hong-Long Chou, Hsinchu County (TW); Ru-Wen Hsia, Taipei City (TW); Yuan-Lin Liao, Hsinchu City (TW); Chia-Hsin Liao, Taoyuan City (TW)

(73) Assignee: ALTEK CORPORATION, Hsinchu City (TW)

(21) Appl. No.: 16/210,001

(22) Filed: Dec. 5, 2018

(30) Foreign Application Priority Data
May 8, 2018 (TW) 107115535

(51) Int. Cl. G06T 5/00; H04N 5/235; G06T 5/50; G06T 7/579; G06T 7/194; G06T 7/174

(52) U.S. Cl. CPC G06T 5/009; H04N 5/2355; G06T 5/50; G06T 2207/20208; G06T 7/194; G06T 7/174; G06T 2207/20221; G06T 7/579

(57) ABSTRACT

An image processing method and an image processing device are provided. The image processing method includes: obtaining images and calculating depth information corresponding to the images via a processor; segmenting each of the images into a foreground area and a background area according to color information, brightness information, and the depth information of the images via the processor; obtaining the foreground area of a first image of the images via the processor, wherein a brightness of the foreground area of the first image is greater than a first threshold; obtaining the background area of a second image of the images via the processor, wherein a brightness of the background area of the second image is less than a second threshold; and fusing the foreground area of the first image and the background area of the second image via the processor to generate a high dynamic range image.

### CROSS-REFERENCE TO RELATED APPLICATION

This application claims the priority benefit of Taiwan application serial no. 107115535, filed on May 8, 2018. The entirety of the above-mentioned patent application is hereby incorporated by reference herein and made a part of this specification.

### BACKGROUND OF THE INVENTION

### Field of the Invention

The invention relates to an image processing method and an image processing device, and more particularly, to an image processing method and an image processing device requiring less system resource to generate a clear image.

### Description of Related Art

In the traditional single image capture technique, if the brightness of a scene shows high contrast, then the brightness of a subject (e.g., a person) is less due to the limit of the dynamic range of the sensor. The selection of a longer exposure time to increase the image brightness of the dark area results in overexposure to other bright areas in the image due to excessive exposure time. That is, an image having normal subject brightness and an overexposed background is generated, as shown in FIG. 1. The selection of a shorter exposure time to prevent overexposure to the bright areas results in a subject area in the image that is too dark due to lack of exposure as shown in FIG. 2. Therefore, regardless of how the exposure time is configured, an image having a subject and a background that are clear and bright cannot be captured.

To solve the issue above, a high dynamic image processing technique has been proposed. The high dynamic image processing technique involves stacking a plurality of images into a single high dynamic range image and then adjusting the brightness of each of the pixels via a tone reproduction technique one at a time. The high dynamic image processing technique can more accurately restore the dynamic range of the scene to prevent an overexposed area or overly-dark area in the image and can show details of bright areas and dark areas. However, the high dynamic image processing technique generally requires a plurality of images of different exposure times, and therefore more calculation time and memory space are needed to complete image fusion. To reduce image fusion time, a method of regional tone reproduction has been proposed. However, regional tone reproduction readily generates a halo issue, such as an abnormal white edge or black edge appearing at a black and white border in the image, as shown in a halo 300 in FIG. 3. Therefore, how to generate a clear image using less system resource is an object for those skilled in the art.

### SUMMARY OF THE INVENTION

Accordingly, the invention provides an image processing method and an image processing device that can generate a clear image using less system resource.

The invention provides an image processing method including the following. A plurality of images is obtained and a plurality of depth information corresponding to the images is calculated via a processor. Each of the images is segmented into a foreground area and a background area according to a plurality of color information, a plurality of brightness information, and the depth information of the images via the processor. The foreground area of a first image of the images is obtained via the processor, wherein a brightness of the foreground area of the first image is greater than a first threshold. The background area of a second image of the images is obtained via the processor, wherein a brightness of the background area of the second image is less than a second threshold. The foreground area of the first image and the background area of the second image are fused via the processor to generate a high dynamic range image.

In an embodiment of the invention, the image processing method further includes the following. An image filtering operation is performed on the background area of the second image via the processor, and the image filtering operation includes a background blurring operation and an object removal operation.

In an embodiment of the invention, the image processing method further includes the following. An offset corresponding to an object is obtained from the foreground area or the background area of the images via the processor and a transformation operation is performed on the images according to the offset.

In an embodiment of the invention, the image processing method further includes the following. A tone reproduction operation is performed on an edge of each of the foreground area and the background area of the high dynamic range image according to a brightness of each of the foreground area of the first image and the background area of the second image via the processor.

In an embodiment of the invention, the depth information is obtained according to a multi-lens image or a structural light information.

The invention provides an image processing device including a processor, an image sensor coupled to the processor and capturing a plurality of images, and a memory coupled to the processor. The processor obtains a plurality of images and calculates a plurality of depth information corresponding to the images, segments each of the images into a foreground area and a background area according to a plurality of color information, a plurality of brightness information, and the depth information of the images, obtains the foreground area of a first image of the images, wherein a brightness of the foreground area of the first image is greater than a first threshold, obtains the background area of a second image of the images, wherein a brightness of the background area of the second image is less than a second threshold, and fuses the foreground area of the first image and the background area of the second image to generate a high dynamic range image.

In an embodiment of the invention, the processor performs an image filtering operation on the background area of the second image, and the image filtering operation includes a background blurring operation and an object removal operation.

In an embodiment of the invention, the processor obtains an offset corresponding to an object from the foreground area or the background area of the images and performs a transformation operation on the images according to the offset.

In an embodiment of the invention, the processor performs a tone reproduction operation on an edge of each of the foreground area and the background area of the high dynamic range image according to a brightness of each of the foreground area of the first image and the background area of the second image.

In an embodiment of the invention, the depth information is obtained according to a multi-lens image or a structural light information.

Based on the above, in the image processing method and the image processing device of the invention, the depth information of a plurality of images is calculated and each of the images is segmented into a foreground area and a background area according to the color information, brightness information, and depth information of the images and then a foreground area having a brightness greater than a first threshold and a background area having a brightness less than a second threshold are obtained from the plurality of images. Lastly, the foreground area and the background image are fused to generate a high dynamic range image. By applying an image segmentation technique in a high dynamic range image and performing image fusion based on area, pixel brightness does not need to be adjusted one at a time, and operation time can therefore be reduced and a high dynamic range image having high quality can be obtained.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic of an image having an overexposed background in the prior art of the invention.

FIG. 2 is a schematic of an image having an overly-dark subject in the prior art of the invention.

FIG. 3 is a schematic of a halo phenomenon caused by regional tone reproduction in the prior art of the invention.

FIG. 4 is a block diagram of an image processing device according to an embodiment of the invention.

FIG. 5 is a flowchart of an image processing method according to an embodiment of the invention.

FIG. 6 is a schematic of a high dynamic range image according to an embodiment of the invention.

FIG. 7 is a flowchart of an image processing method according to another embodiment of the invention.

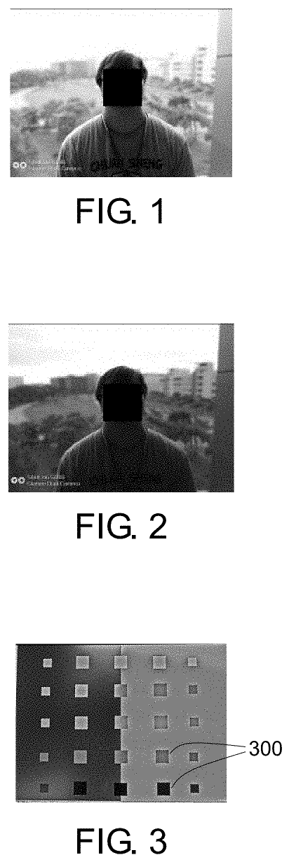

### DESCRIPTION OF THE EMBODIMENTS

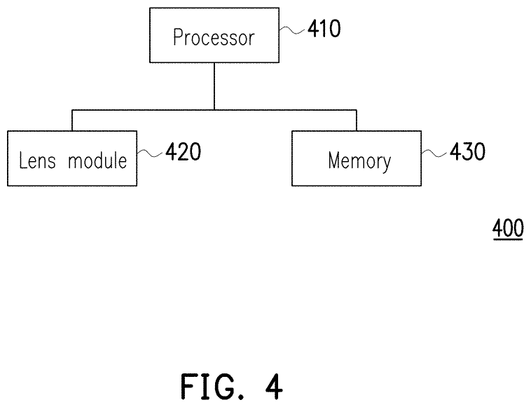

FIG. 4 is a block diagram of an image processing device according to an embodiment of the invention.

Referring to FIG. 4, an image processing device 400 of the invention includes a processor 410, a lens module 420, and a memory 430. The lens module 420 can capture one to a plurality of images and send the images to the memory 430 for long-term storage or temporary storage. The processor 410 can calculate one to a plurality of images in the memory 430 to obtain a high dynamic range image.

The processor 410 can be a central processing unit (CPU) or a programmable general-use or special-use microprocessor, digital signal processor (DSP), programmable controller, application-specific integrated circuit (ASIC), or other similar devices or a combination thereof. The lens module 420 can include a lens (not shown in figures) and an image sensor (not shown in figures). The image sensor can be a charge-coupled device (CCD) image sensor, complementary metal-oxide-semiconductor (CMOS), or other types of image sensors. The memory 430 can be any form of a fixed or movable random access memory (RAM), read-only memory (ROM), flash memory, hard disk drive (HDD), solid-state drive (SSD), or similar devices or a combination of the above devices.

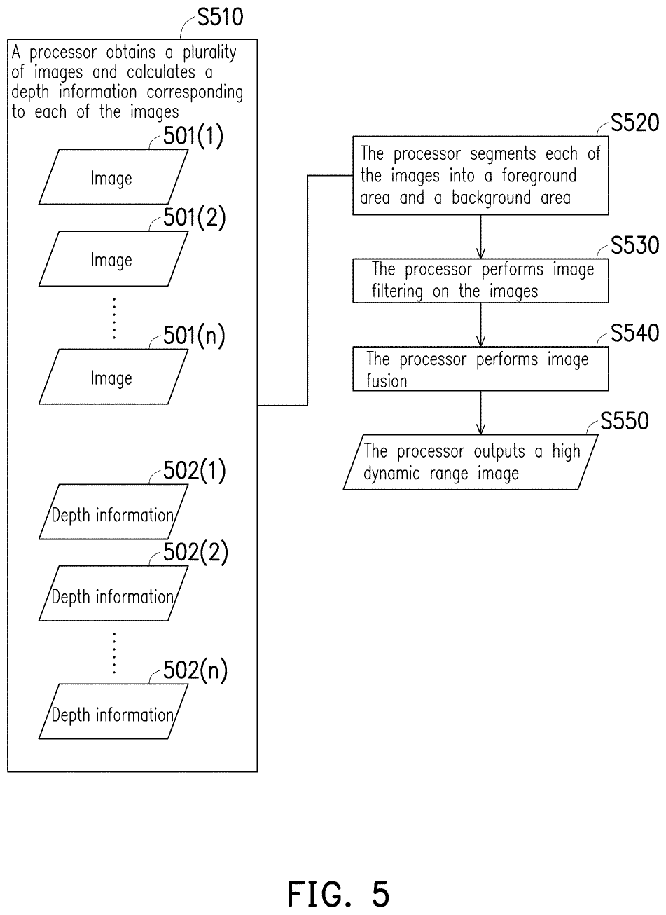

FIG. 5 is a flowchart of an image processing method according to an embodiment of the invention.

Referring to FIG. 5, in step S510, the processor 410 obtains a plurality of images and calculates a depth information corresponding to each of the images. For instance, the processor 410 obtains images 501(1) to 501(n) and respectively calculates depth information 502(1) to 502(n) corresponding to the images 501(1) to 501(n). The images 501(1) to 501(n) are images of different exposure times. In an embodiment, the depth information of each of the images can be obtained by calculating an image captured by a double lens or a triple lens. In another embodiment, the depth information of each of the images can be obtained by collecting depth data via a three-dimensional structured light depth sensor. In the invention, the method of obtaining the depth information of the images is not limited.

In step S520, the processor 410 segments each of the images into a foreground area and a background area. Specifically, the processor 410 can distinguish the foreground area and the background area in the image according to the color information and brightness information of the image pixels and the depth information calculated in step S510.

In step S530, the processor 410 performs image filtering on the images. Specifically, after background pixels and foreground pixels are obtained, the processor 410 can perform object removal processing on foreground pixels having a brightness greater than a threshold (e.g., a first threshold) to remove non-subject wandering people. A pixel brightness greater than the first threshold indicates the brightness of the foreground pixels are not too low. The processor 410 can further perform blur processing on background pixels having a brightness less than a threshold (e.g., a second threshold) to obtain a blurred background image. A pixel brightness less than the second threshold indicates the background pixels are not overexposed.

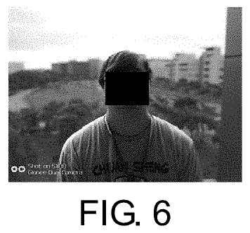

In step S540, the processor 410 performs image fusion. Specifically, the processor 410 selects foreground pixels having normal brightness (i.e., not too dark) after image cutting and fuses the selected foreground pixels in the background image that are not overexposed. As a result, an image having a blurred background and retaining high dynamic range image details can be obtained, as shown in FIG. 6.

In step S550, the processor 410 outputs a high dynamic range image.

The present embodiment provides a high dynamic range image calculation method based on area that directly divides images into a foreground area and a background area then fuses suitable foreground areas and background areas into a high dynamic range image. In the present embodiment, since the brightness of each of the pixels is not adjusted for image fusion, the operation time of the high dynamic range image can be significantly reduced.

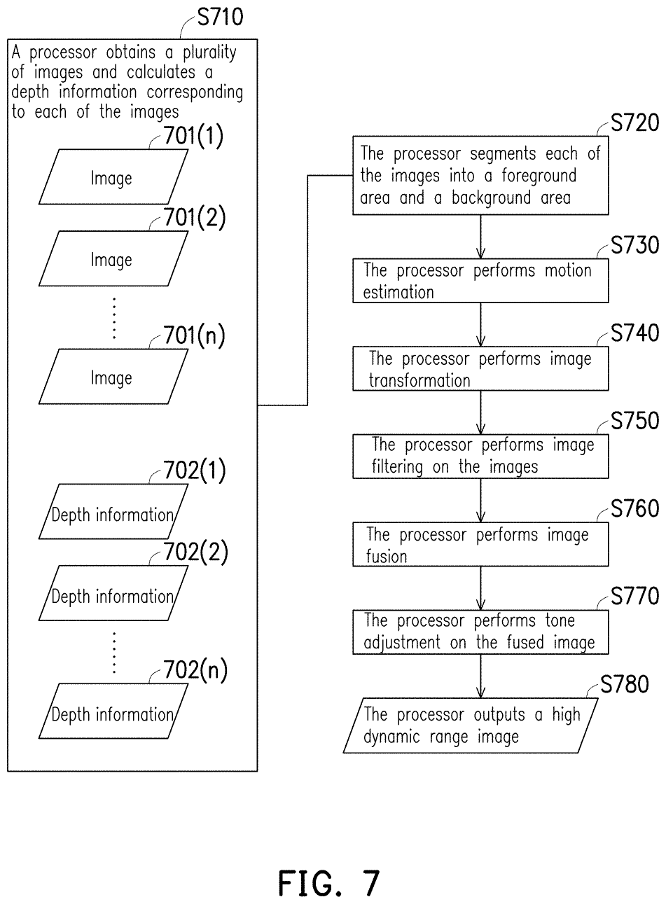

FIG. 7 is a flowchart of an image processing method according to another embodiment of the invention.

Referring to FIG. 7, in step S710, the processor 410 obtains a plurality of images and calculates a depth information corresponding to each of the images. For instance, the processor 410 obtains images 701(1) to 701(n) and respectively calculates depth information 702(1) to 702(n) corresponding to the images 701(1) to 701(n). The images 701(1) to 701(n) are images of different exposure times.

In step S720, the processor 410 segments each of the images into a foreground area and a background area. Specifically, the processor 410 can distinguish the foreground area and the background area in the images according to the color information and brightness information of the image pixels and the depth information calculated in step S710.

In step S730, the processor 410 performs motion estimation. In step S740, the processor 410 performs image transformation. Specifically, the processor 410 can estimate the amount of movement of a foreground object or background object and perform image transformation according to the amount of movement to reduce the occurrence of fused image distortion. As a result, the occurrence of image offset caused by a shaky hand or other movements when capturing a plurality of images can be prevented.

In step S750, the processor 410 performs image filtering on the images. Specifically, after the background pixels and the foreground pixels are obtained, the processor 410 can perform object removal processing on foreground pixels having a brightness greater than a threshold (e.g., a first threshold) to remove non-subject wandering people. A pixel brightness greater than the first threshold indicates the brightness of the foreground pixels is not too low. The processor 410 can further perform blur processing on background pixels having a brightness less than a threshold (e.g., a second threshold) to obtain a blurred background image. A pixel brightness less than the second threshold indicates the background pixels are not overexposed.

In step S760, the processor 410 performs image fusion. Specifically, the processor 410 selects foreground pixels having normal brightness (i.e., not too dark) after image cutting and fuses the selected foreground pixels in the background image that are not overexposed.

In step S770, the processor 410 performs tone adjustment on the fused image. Specifically, the processor 410 can adjust the overall contrast effect of the fused image to obtain an image having higher contrast. Moreover, the processor 410 can further perform a tone reproduction operation on an edge of each of the foreground area and the background area of the high dynamic range image according to the brightness of each of the selected foreground area and background area to solve the halo issue generated by the traditional regional tone reproduction operation.

In step S780, the processor 410 outputs a high dynamic range image.

In the present embodiment, the issue of inaccurate fused image caused by a shaky hand or other movements when capturing a plurality of images is alleviated via a method such as motion estimation and transformation. In the present embodiment, the overall contrast effect of the fused image can be further adjusted to generate a high dynamic range image having better quality.

Based on the above, in the image processing method and the image processing device of the invention, the depth information of a plurality of images is calculated and each of the images is segmented into a foreground area and a background area according to the color information, brightness information, and depth information of the images and then a foreground area having a brightness greater than a first threshold and a background area having a brightness less than a second threshold are obtained from the plurality of images. Lastly, the foreground area and the background image are fused to generate a high dynamic range image. By applying an image segmentation technique in a high dynamic range image and performing image fusion based on area, pixel brightness does not need to be adjusted one at a time, and operation time can therefore be reduced and a high dynamic range image having high quality can be obtained.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. An image processing method, comprising:
obtaining a plurality of images and calculating a plurality of depth information corresponding to the images via a processor;
segmenting each of the images into a foreground area and a background area according to a plurality of color information, a plurality of brightness information, and the depth information via the processor;
obtaining the foreground area of a first image of the images via the processor, wherein a brightness of the foreground area of the first image is greater than a first threshold;
obtaining the background area of a second image of the images via the processor, wherein a brightness of the background area of the second image is less than a second threshold; and
fusing the foreground area of the first image and the background area of the second image via the processor to generate a high dynamic range image.

2. The image processing method of claim 1, further comprising performing an image filtering operation on the background area of the second image via the processor, and the image filtering operation comprises a background blurring operation and an object removal operation.

3. The image processing method of claim 1, further comprising obtaining an offset corresponding to an object from the foreground area or the background area of the images via the processor and performing a transformation operation on the images according to the offset.

4. The image processing method of claim 1, further comprising performing a tone reproduction operation on an edge of each of the foreground area and the background area of the high dynamic range image according to a brightness of each of the foreground area of the first image and the background area of the second image via the processor.

5. The image processing method of claim 1, wherein the depth information is obtained according to a multi-lens image or a structural light information.

6. An image processing device, comprising:
a processor;
an image sensor coupled to the processor and capturing a plurality of images; and
a memory coupled to the processor, wherein the processor
obtains the images and a plurality of depth information corresponding to the images;
segments each of the images into a foreground area and a background area according to a plurality of color information, a plurality of brightness information, and the depth information of the images;
obtains the foreground area of a first image of the images, wherein a brightness of the foreground area of the first image is greater than a first threshold;
obtains the background area of a second image of the images, wherein a brightness of the background area of the second image is less than a second threshold; and
fuses the foreground area of the first image and the background area of the second image to generate a high dynamic range image.

7. The image processing device of claim 6, wherein the processor performs an image filtering operation on the background area of the second image, and the image filtering operation comprises a background blurring operation and an object removal operation.

8. The image processing device of claim 6, wherein the processor obtains an offset corresponding to an object from the foreground area or the background area of the images and performs a transformation operation on the images according to the offset.

9. The image processing device of claim 6, wherein the processor performs a tone reproduction operation on an edge of each of the foreground area and the background area of the high dynamic range image according to a brightness of each of the foreground area of the first image and the background area of the second image.

10. The image processing device of claim 6, wherein the depth information is obtained according to a multi-lens image or a structural light information.

11. An image processing method, comprising:
obtaining a plurality of images and a plurality of depth information corresponding to the images;
segmenting each of the images into a foreground area and a background area according to a plurality of color information, a plurality of brightness information, and the depth information of the images; and
generating a high dynamic range image according to the foreground area of one of the images and the background area of one of the images.

12. An image processing device, comprising:
a processor;
an image sensor coupled to the processor and capturing a plurality of images; and
a memory coupled to the processor, wherein the processor
obtains a plurality of images and a plurality of depth information corresponding to the images;
segments each of the images into a foreground area and a background area according to a plurality of color information, a plurality of brightness information, and the depth information of the images; and
generates a high dynamic range image according to the foreground area of one of the images and the background area of one of the images.
